(19) United States
(12) Patent Application Publication
(10) Pub. No.: US 2024/0258019 A1
(43) Pub. Date: Aug. 1, 2024

(54) COIL COMPONENT

(71) Applicant: SAMSUNG ELECTRO-MECHANICS CO., LTD., Suwon-si (KR)

(72) Inventors: Ju Hwan YANG, Suwon-si (KR); Byeong Cheol MOON, Suwon-si (KR); Han LEE, Suwon-si (KR); Jae Hun KIM, Suwon-si (KR); In Young KANG, Suwon-si (KR); Boum Seock KIM, Suwon-si (KR)

(73) Assignee: SAMSUNG ELECTRO-MECHANICS CO., LTD., Suwon-si (KR)

(21) Appl. No.: 18/383,169

(22) Filed: Oct. 24, 2023

(30) Foreign Application Priority Data
Jan. 31, 2023 (KR) 10-2023-0012752

(51) Int. Cl. H01F 27/29; H01F 27/32

(52) U.S. Cl. CPC H01F 27/292; H01F 27/323

(57) ABSTRACT

A coil component includes a body having a first surface and a second surface opposing each other in a first direction and respectively having a recess formed therein, and a third surface and a fourth surface connecting the first surface and the second surface and opposing each other in a second direction, a coil including a coil portion disposed within the body and having a plurality of turns, a first lead-out portion disposed within the body and extending to the recess of the first surface of the body, and a second lead-out portion having at least a portion extending from an outermost turn of the coil portion to the recess of the second surface of the body, and first and second external electrodes disposed on the third surface of the body and extending to the recess to be connected to the first and second lead-out portions, respectively.

### CROSS-REFERENCE TO RELATED APPLICATION (S)

This application claims benefit of priority to Korean Patent Application No. 10-2023-0012752 filed on Jan. 31, 2023 in the Korean Intellectual Property Office, the disclosure of which is incorporated herein by reference in its entirety.

### TECHNICAL FIELD

The present disclosure relates to a coil component.

An inductor, a coil component, is a representative passive electronic component used in electronic devices, along with a resistor and a capacitor.

As electronic devices are designed to have higher performance and a reduced size, electronic components used in electronic devices have been increased in number and reduced in size.

There is a demand for a coil component capable of improving inductance characteristics by increasing effective volume while reducing overall thickness.

### RELATED ART DOCUMENT

### Patent Document

Patent Document 1: JP Patent Application Publication No. 2019-134141

### SUMMARY

An aspect of the present disclosure is to implement a coil component having an increased central core area and effective volume by applying a single-layer coil structure.

Another aspect of the present disclosure is to implement a coil component being advantageous for integration and reducing the risk of short circuit, when the coil component is mounted on a PCB board, by exposing an external electrode only to a lower surface of the coil component.

According to an aspect of the present disclosure, there is provided a coil component including a body having a first surface and a second surface opposing each other in a first direction, the first surface and the second surface respectively having a recess, and a third surface and a fourth surface connecting the first surface and the second surface to each other, the third surface and the fourth surface opposing each other in a second direction, a coil including a support member disposed within the body, the support member having one surface and the other surface opposing each other, a coil portion having at least a portion disposed on the one surface of the support member, the coil portion having a plurality of turns, a first lead-out portion disposed on the other surface of the support member, the first lead-out portion extending to the recess of the first surface of the body, a via connecting an innermost turn of the coil portion and the first lead-out portion to each other, and a second lead-out portion having at least a portion extending from an outermost turn of the coil portion to the recess formed in the second surface of the body, and first and second external electrodes disposed on the third surface of the body, the first and second external electrodes extending to the recess to be connected to the first and second lead-out portions, respectively.

According to another aspect of the present disclosure, there is provided a coil component including a body having a first surface and a second surface respectively having a recess, the first surface and the second surface opposing each other, a support member disposed within the body, the support member having one surface and the other surface opposing each other, a coil including a coil portion in contact with the one surface of the support member but not the other surface of the support member, the coil portion having a plurality of turns, wherein an aspect ratio of each of the plurality of turns is greater than 0.04 and less than or equal to 15, a first lead-out portion disposed on the other surface of the support member, the first lead-out portion extending to the first surface of the body, a via passing through the support member to connect an innermost turn of the coil portion and the first lead-out portion to each other, and a second lead-out portion extending from an outermost turn of the coil portion to the second surface of the body, and first and second external electrodes disposed along an external surface of the recess, the first and second external electrodes respectively connected to the first and second lead-out portions.

According to an aspect of the present disclosure, a central core area and an effective volume may be increased by applying a single-layer coil structure to a thin-film coil component.

According to another aspect of the present disclosure, an external electrode may only be exposed to a lower surface of a coil component, thereby reducing the risk of a short circuit and being advantageous for integration, when the coil component is mounted on a PCB board.

### BRIEF DESCRIPTION OF DRAWINGS

The above and other aspects, features, and advantages of the present disclosure will be more clearly understood from the following description, taken in detailed conjunction with the accompanying drawings, in which:

FIG. 1 is a schematic perspective view of a coil component according to a first embodiment of the present disclosure;

FIG. 2 is an assembly view illustrating a bonding relationship between some components of FIG. 1;

FIG. 3 is a plan view of FIG. 1;

FIG. 4 is a cross-sectional view taken along line I-I′ of FIG. 1;

FIG. 5 is a cross-sectional view taken along line II-II′ of FIG. 1;

FIG. 6 illustrates a coil component according to a second example embodiment of the present disclosure, and is a view corresponding to FIG. 4;

FIG. 7 illustrates a coil component according to a third example embodiment of the present disclosure, and is a view corresponding to FIG. 4;

FIG. 8 illustrates a coil component according to a fourth example embodiment of the present disclosure, and is a view corresponding to FIG. 4; and

FIG. 9 illustrates a coil component according to a fifth example embodiment of the present disclosure, and is a view corresponding to FIG. 4.

### DETAILED DESCRIPTION

The terminology used herein is for the purpose of describing particular example embodiments only and is not to be limiting of the example embodiments. As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof. In addition, the terms “disposed on,” “positioned on,” and the like, may mean the element is positioned on or below a target portion, and does not necessarily mean that the element is positioned on an upper side of the target portion with respect to a direction of gravity.

The terms “coupled to,” “connected to,” and the like, may not only indicate that elements are directly and physically in contact with each other, but also include a configuration in which the other element is interposed between the elements such that the elements are also in contact with the other component.

The size and thickness of each element illustrated in the drawings is arbitrarily represented for ease of description, but the present disclosure is not necessarily limited to those illustrated herein.

In the drawings, an L direction may be defined as a first direction or a length direction, a T direction may be defined as a second direction or a thickness direction, and a W direction may be defined as a third direction or a width direction.

Hereinafter, a coil component according to an example embodiment of the present disclosure will be described in detail with reference to the accompanying drawings, and in the description with reference to the accompanying drawings, the same or corresponding elements are denoted by the same reference numerals and repeated descriptions thereof will be omitted.

Various types of electronic components may be used in electronic devices, and various types of coil components may be appropriately used between such electronic components to remove noise.

That is, in an electronic device, a coil component may be used as a power inductor, a high-frequency (HF) inductor, a general bead, a high-frequency bead (GHz bead), a common mode filter, or the like.

### First Example Embodiment

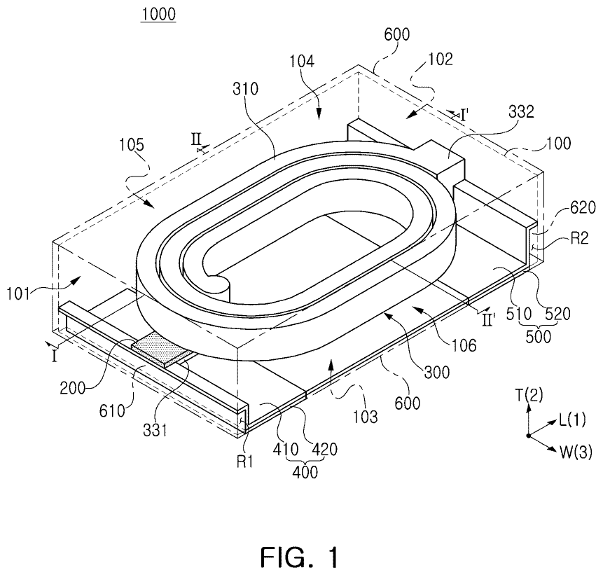

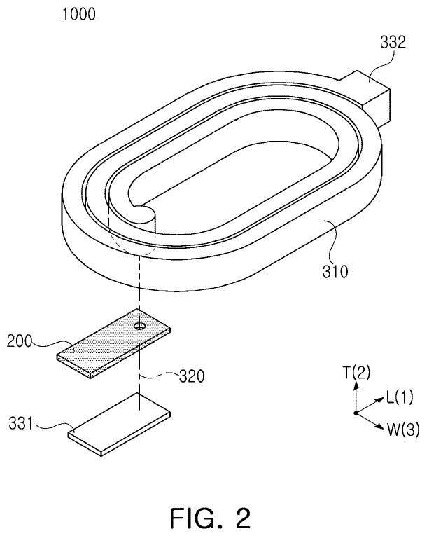

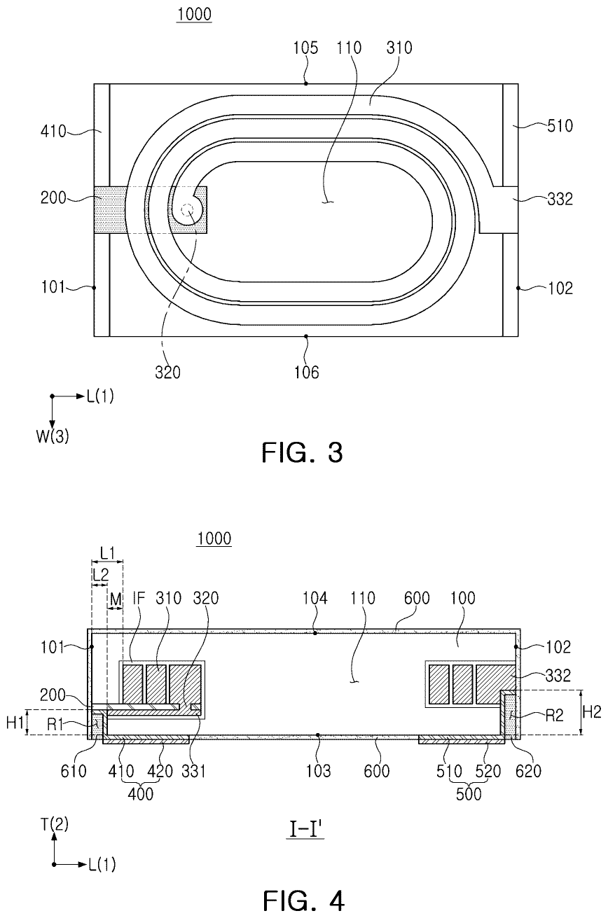

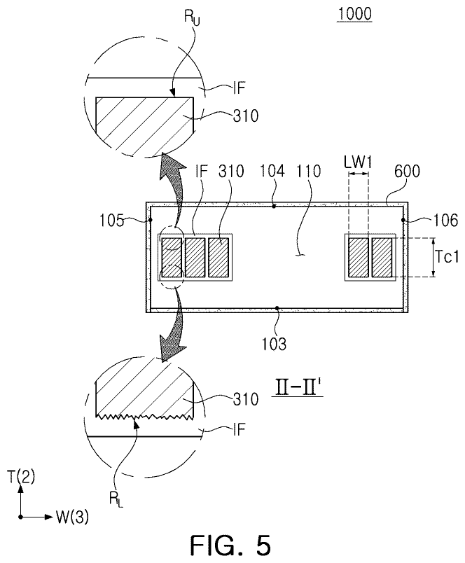

FIG. 1 is a schematic perspective view of a coil component according to a first embodiment of the present disclosure. FIG. 2 is an assembly view illustrating a bonding relationship between some components of FIG. 1. FIG. 3 is a plan view of FIG. 1. FIG. 4 is a cross-sectional view taken along line I-I′ of FIG. 1. FIG. 5 is a cross-sectional view taken along line II-II′ of FIG. 1.

In FIG. 3, an insulating layer 600 on a body 100, applicable to the present example embodiment, is omitted and illustrated in order to more clearly illustrate bonding between elements.

Referring to FIGS. 1 to 5, a coil component 1000 according to a first example embodiment of the present disclosure may include a body 100, a support member 200, a coil 300, and external electrodes 400 and 500, and may further include the insulating layer 600 covering the body 100.

The coil component 1000 according to the present example embodiment may have a single-layer coil structure in which a coil portion 310 is disposed on only one surface of the support member 200. In addition, the external electrodes 400 and 500 may be connected to lead-out portions 331 and 332, respectively connected to the coil 300 and extending to the recesses R1 and R2, and the external electrodes 400 and 500 may extend to a lower surface of the body 100, that is, a third surface 103, thereby implementing an electrode structure.

In particular, the support member 200 may be removed except for only a shape corresponding to that of a first lead-out portion 331, such that an area and effective volume of a core 110 centered on the coil portion 310 may be increased, thereby improving inductance characteristics.

Hereinafter, main elements included in the coil component 1000 according to the present example embodiment will be described in detail.

The body 100 may form the exterior of the coil component 1000 according to the present example embodiment, and may include the support member 200 and the coil 300 buried therein.

The body 100 may have an overall hexahedral shape.

Referring to FIG. 1, the body 100 may have a first surface 101 and a second surface 102 opposing each other in a length direction L (first direction), a third surface 103 and a fourth surface 104 opposing each other in a thickness direction T (second direction), and a fifth surface 105 and a sixth surface 106 opposing each other in a width direction W (third direction). Each of the first surface 101, the second surface 102, the fifth surface 105, and the sixth surface 106 of the body 100 may correspond to a wall surface of the body 100 connecting the third surface 103 and the fourth surface 104 to each other.

For example, the body 100 may be formed such that the coil component 1000 according to the present example embodiment, including the external electrodes 400 and 500, has a length of 2.5 mm, a width of 2.0 mm, and a thickness of 1.0 mm, has a length of 2.0 mm, a width of 1.2 mm, and a thickness of 0.65 mm, has a length of 1.6 mm, a width of 0.8 mm, and a thickness of 0.8 mm, has a length of 1.4 mm, a width of 1.2 mm, and a thickness of 0.62 mm, has a length of 1.0 mm, a width of 0.7 mm, and a thickness of 0.65 mm, has a length of 1.0 mm, a width of 0.5 mm, and a thickness of 0.8 mm, or has a length of 0.8 mm, a width of 0.4 mm, a thickness of 0.65 mm. The above-described dimensions refer to dimensions not reflecting a process error, such that it should be considered that the dimensions are within a range admitted as a process error.

With respect to an optical microscope or scanning electron microscope (SEM) image of a length directional (L)-thickness directional (T) cross-section of a width directional (W) central portion of the coil component 1000, the above-described length of the coil component 1000 may refer to a maximum value among dimensions of a plurality of line segments connecting, to each other, two outermost boundary lines of the coil component 1000 opposing each other in the length direction L illustrated in the image, to be parallel to the length direction L, the plurality of line segments spaced apart from each other in the thickness direction T. Other methods and/or tools appreciated by one of ordinary skill in the art, even if not described in the present disclosure, may also be used. Alternately, the above-described length of the coil component 1000 may refer to a minimum value among the dimensions of the plurality of line segments. Alternately, the above-described length of the coil component 1000 may refer to an arithmetic mean value of at least three dimensions among the dimensions of the plurality of segments. Here, the plurality of line segments, parallel to the length direction L, may be equally spaced apart from each other in the thickness direction T, but the present disclosure is not limited thereto.

With respect to the optical microscope or SEM image of the length directional (L)-thickness directional (T) cross-section of the width directional (W) central portion of the coil component 1000, the above-described thickness of the coil component 1000 may refer to a maximum value among dimensions of a plurality of line segments connecting, to each other, two outermost boundary lines of the coil component 1000 opposing each other in the thickness direction T illustrated in the image, to be parallel to the thickness direction T, the plurality of line segments spaced apart from each other in the length direction L. Other methods and/or tools appreciated by one of ordinary skill in the art, even if not described in the present disclosure, may also be used. Alternately, the above-described thickness of the coil component 1000 may refer to a minimum value among the dimensions of the plurality of line segments. Alternately, the above-described thickness of the coil component 1000 may refer to an arithmetic mean value of at least three dimensions among the dimensions of the plurality of segments. Here, the plurality of line segments, parallel to the thickness direction, T may be equally spaced apart from each other in the length direction L, but the present disclosure is not limited thereto.

With an optical microscope or SEM image of a length directional (L)-width directional (W) cross-section of a thickness directional (W) central portion of the coil component 1000, the above-described width of the coil component 1000 may refer to a maximum value among dimensions of a plurality of line segments connecting, to each other, two outermost boundary lines of the coil component 1000 opposing each other in the width direction W illustrated in the image, to be parallel to the width direction W, the plurality of line segments spaced apart from each other in the length direction L. Other methods and/or tools appreciated by one of ordinary skill in the art, even if not described in the present disclosure, may also be used. Alternately, the above-described width of the coil component 1000 may refer to a minimum value among the dimensions of the plurality of line segments. Alternately, the above-described width of the coil component 1000 may refer to an arithmetic mean value of at least three dimensions among the dimensions of the plurality of segments. Here, the plurality of line segments, parallel to the width direction W, may be equally spaced apart from each other in the length direction L, but the present disclosure is not limited thereto.

Alternatively, each of the length, width, and thickness of the coil component 1000 may be measured by a micrometer measurement method. Each of the length, width, and thickness of the coil component 1000 may be measured using the micrometer measurement method by setting a zero point with a gage repeatability and reproducibility (R&R) micrometer, inserting the coil component 1000 according to the present example embodiment into a tip of the micrometer, and turning a measurement lever of the micrometer. In measuring the length of the coil component 1000 using the micrometer measurement method, the length of the coil component 1000 may refer to a value measured once or an arithmetic mean of values measured multiple times, which may be applied to the width and thickness of the coil component 1000 in the same manner.

The body 100 may include a magnetic material and a resin. Specifically, the body 100 may be formed by laminating one or more magnetic composite sheets in which the magnetic material is dispersed in the resin. The magnetic material may be formed of a magnetic material such as ferrite.

The magnetic material may be ferrite or metal magnetic powder.

The ferrite powder may be, for example, at least one of spinel-type ferrite such as Mg—Zn-based ferrite, Mn—Zn-based ferrite, Mn—Mg-based ferrite, Cu—Zn-based ferrite, Mg—Mn—Sr-based ferrite, Ni—Zn-based ferrite, or the like, hexagonal ferrite such as Ba—Zn-based ferrite, Ba—Mg-based ferrite, Ba—Ni-based ferrite, Ba—Co-based ferrite, Ba—Ni—Co-based ferrite, or the like, garnet-type ferrite such as Y-based ferrite or the like, and Li-based ferrite.

The magnetic metal power may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the magnetic metal power may be at least one of pure iron powder, Fe—Si-based alloy power, Fe—Si—Al-based alloy power, Fe—Ni-based alloy power, Fe—Ni—Mo-based alloy power, Fe—Ni—Mo—Cu-based alloy power, Fe—Co-based alloy power, Fe—Ni—Co-based alloy power, Fe—Cr-based alloy power, Fe—Cr—Si-based alloy power, Fe—Si—Cu—Nb-based alloy power, Fe—Ni—Cr-based alloy power, and Fe—Cr—Al-based alloy power. The magnetic metal powder may be amorphous or crystalline. For example, the magnetic metal powder may be Fe—Si—B—Cr-based amorphous alloy powder, but is not necessarily limited thereto.

The magnetic metal powder may have an average diameter of about 0.1 μm to about 30 μm, but the present disclosure is not limited thereto.

The body 100 may include two or more types of magnetic materials dispersed in the resin. Here, the different types of magnetic materials mean that the magnetic materials dispersed in the resin are distinguished from each other by one of an average diameter, a composition, crystallinity, and a shape.

The resin may include, but the present disclosure is not limited to, epoxy, polyimide, a liquid crystal polymer, or the like alone or in combination.

Referring to FIGS. 3 to 5, the body 100 may include a core 110 disposed in a central region of the coil portion 310 of the coil 300. The core 110 may be formed by filling the central region of the coil portion 310 with a magnetic composite sheet, but the present disclosure is not limited thereto.

In the present example embodiment, a through-hole may not be formed by removing a central portion of the support member 200, but the support member 200 may be removed except for only a shape corresponding to that of the first lead-out portion 331 disposed on a lower surface thereof. Thereafter, the core 110 may be disposed in the central region of the coil portion 310.

Referring to FIGS. 1 and 4, recesses R1 and R2 may be formed on the first surface 101 and the second surface 102 of the body 100, respectively.

Specifically, a first recess R1 may be formed between the first surface 101 and the third surface 103 of the body 100, and a second recess R2 may be formed between the second surface 102 and the third surface 103 of the body 100.

The first recess R1 may extend up to the fifth surface 105 and the sixth surface 106 of the body 100 in a third direction W. In addition, the second recess R2 may extend up to the fifth surface 105 and the sixth surface 106 of the body 100 in the third direction W. However, the present disclosure is not limited thereto. For example, the recesses R1 and R2 may not extend up to the fifth surface 105 and the sixth surface 106, and may be formed to be narrower than a width of the body in the third direction W.

The recesses R1 and R2 may not extend up to the fourth surface 104 of the body 100. That is, the recesses R1 and R2 may not pass through the body 100 in a second direction T of the body 100.

Referring to FIG. 4, a maximum length L2 of the first recess R1 in the first direction L may be shorter than a minimum length L1 between an outermost turn of the coil portion 310 and the first surface 101 of the body 100 in the first direction L. L1 and L2 may be measured by an optical microscope or SEM. Other methods and/or tools appreciated by one of ordinary skill in the art, even if not described in the present disclosure, may also be used.

Through such a structure, a margin M having a predetermined distance may be formed in the first direction L between the external electrode 400 disposed in the first recess R1 and the outermost turn of the coil portion 310. Even when the first recess R1 is formed to be higher than the support member 200 due to a process error, contact between a first external electrode 400 and the coil portion 310 may be prevented, thereby reducing the risk of short circuit defects.

The recesses R1 and R2 may be formed by performing a pre-dicing on one surface of a coil bar at a coil bar level, a state before each coil component is individuated, along a virtual boundary line corresponding to the third direction W of each coil component. In such pre-dicing, a depth of each of a first lead-out portion 331 and a second lead-out portion 332 may be adjusted such that the first lead-out portion 331 and the second lead-out portion 332 are exposed to the recesses R1 and R2, respectively.

Accordingly, referring to FIG. 4, the first and second recesses R1 and R2 according to the present example embodiment may have different heights H1 and H2. Accordingly, the first and second recesses R1 and R2 may have different cross-sectional areas with respect to an L-T cross-section.

Specifically, a height H1 of the first recess R1 in the second direction T may be formed to be lower than a height H2 of the second recess R2 in the second direction T. In addition, with respect to the L-T cross-section, a cross-sectional area of the first recess R1 may be formed to be smaller than a cross-sectional area R2 of the second recess.

The above-described characteristic may be due to a difference in position and shape of the first and second lead-out portions 331 and 332 according to the present example embodiment having a single-layer coil structure. That is, in a pre-dicing process for forming the recesses R1 and R2, the second recess R2 in contact with the second lead-out portion 332 disposed on a level the same as that of the coil portion 310 may be formed to be deeper than the first recess R1 in contact with the first lead-out portion 331 disposed on a lower surface of the support member 200.

Here, with respect to an optical microscope or SEM image of an L-T cross-section of a central portion of the coil component 1000 in the third direction W, each of the heights H1 and H2 of the recesses R1 and R2 may refer to an arithmetic mean value of at least three dimensions among dimensions of a plurality of segments spaced apart from each other in the first direction L and connecting between an uppermost boundary line of each of the recesses R1 and R2 in the second direction T and an extension line of the third surface 103 of the body 100 illustrated in the image, to be parallel to the second direction T. Here, the plurality of line segments, parallel to the second direction T, may be equally spaced apart from each other in the length direction L, but the present disclosure is not limited thereto. Other methods and/or tools appreciated by one of ordinary skill in the art, even if not described in the present disclosure, may also be used.

With respect to the optical microscope image or SEM image of the L-T cross-section of the central portion of the coil component 1000 in the third direction W, each of cross-sectional areas of the recesses R1 and R2 may be calculated using the Image J program tool, but the present disclosure is not limited thereto. Other methods and/or tools appreciated by one of ordinary skill in the art, even if not described in the present disclosure, may also be used.

Internal surfaces of the recesses R1 and R2 may include inner walls substantially parallel to the first and second surfaces 101 and 102 of the body 100, and a bottom surface connecting the inner walls to the first and second surfaces 101 and 102 of the body 100.

However, the present disclosure is not limited thereto. As in the present example embodiment, the internal surface of the first recess R1 may be in the form of a curve connecting, to each other, the first surface 101 and the third surface 103 of the body 100 on the L-T cross-section, such that the inner wall and the bottom surface described above may not be distinguished from each other, and may have an irregular shape. Similarly, the internal surface of the second recess R2 may be in the form of a curve connecting, to each other, the second surface 102 and the third surface 103 of the body 100 on the L-T cross-section, such that the inner wall and the bottom surface described above may not be distinguished from each other, and may have an irregular shape.

The support member 200 may be disposed within the body 100, and may have one surface and the other surface opposing each other. With respect to the direction of FIG. 1, the one surface of the support member 200 may correspond to an upper surface, and the other surface of the support member 200 may correspond to a lower surface.

The support member 200 may support the coil 300. However, in the present example embodiment, the support member 200 may be removed except for a portion thereof after the coil 300 is formed, and thus may be disposed to support a portion of the coil portion 310 and the first lead-out portion 331, among elements of the coil 300. The support member 200 may be excluded in some example embodiments in which the coil 300 corresponds to a winding-type coil or has a coreless structure. As a non-limitative example, when the support member 200 is excluded as described above, a function of supporting the coil 300 may be performed by an insulating film IF to be described below, instead of the support member 200.

Referring to FIGS. 1 to 4, when the support member 200 according to the present example embodiment is projected in the second direction T, outermost boundary lines of the support member 200 and the first lead-out portion 331 may have shapes corresponding to each other.

The coil portion 310 and the second lead-out portion 332 may be disposed on an upper surface of the support member 200, the first lead-out portion 331 may be disposed on the lower surface of the support member 200, and a via 320, connecting an inner end and the first lead-out portion 331 to each other, may be disposed to pass through the support member 200. In this case, the support member 200 may be removed except for a portion thereof corresponding to the first lead-out portion 331. When the first recess R1 is formed, a portion of the first lead-out portion 331 may be additionally removed in a pre-dicing process.

As a result, when projected in the second direction, the support member 200 may have a shape corresponding to that of the first lead-out portion 331 disposed on the lower surface thereof. In the present example embodiment, the support member 200 and the first lead-out portion 331 are illustrated as having a rectangular shape, but the shape is exemplary and the present disclosure is not limited thereto.

The coil component 1000 according to the present example embodiment may have a single-layer coil structure including only one coil portion 310, and the support member 200 may be formed to have a small shape corresponding to that of the first lead-out portion 331. Thus, as compared to a double-layer coil structure in which coils are disposed on both surfaces of the support member 200, an area of the core 110 and a space for filing a magnetic material may be secured, thereby increasing an effective volume and improving inductance characteristics.

Referring to FIGS. 2 to 4, the support member 200 may include a via hole through which the via 320 passes.

The support member 200 according to the present example embodiment may not include a through-hole in which the core 110 is disposed, and the via hole may be disposed between the coil portion 310 and the first lead-out portion 331, not between two coil portions.

The support member 200 may include an insulating material, for example, a thermosetting insulating resin such as an epoxy resin, a thermoplastic insulating resin such as polyimide, or a photosensitive insulating resin, or the support member 200 may include an insulating material in which a reinforcing material such as a glass fiber or an inorganic filler is impregnated with the insulating resin. For example, the support member 200 may be formed of an insulating material such as prepreg, an Ajinomoto build-up film (ABF), FR-4, a bismaleimide triazine (BT) resin, a photo-imageable dielectric (PID), a copper clad laminate (CCL), or the like, but the present disclosure is not limited thereto.

The inorganic filler may be at least one selected from the group consisting of silica (SiO₂), alumina (Al₂O₃), silicon carbide (SiC), barium sulfate (BaSO₄), talc, mud, a mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃).

When the support member 200 is formed an insulating material including a reinforcing material, the support member 200 may provide more excellent rigidity. When the support member 200 is formed of an insulating material including no glass fiber, it may be advantageous in reducing a thickness of the coil component 1000 by thinning an overall thickness (indicating a sum of dimensions of the coil 300 and the support member 200 in the second direction T of FIG. 1) of the support member 200 and the coil 300. When the support member 200 is formed of an insulating material including a photosensitive insulating resin, the number of processes for forming the coil 300 may be reduced, thereby being advantageous in reducing production costs, and forming a fine via 320. The support member 200 may have a thickness of, for example, 10 μm to 50 μm, but the present disclosure is not limited thereto.

The coil 300 may be buried in the body 100 to exhibit characteristics of the coil component 1000. For example, when the coil component 1000 according to the present example embodiment is used as a power inductor, the coil 300 may serve to stabilize power of an electronic device by storing an electric field as a magnetic field and maintaining an output voltage.

The coil 300 may include the coil portion 310, the via 320, and first and second lead-out portions 331 and 332.

Referring to FIGS. 1 and 2, the coil portion 311 and the second lead-out portion 332 may be disposed on the one surface (upper surface) of the support member 200, opposing the fourth surface 104 of the body 100, and the first lead-out portion 331 may be disposed on the other surface (lower surface) of the support member 200, opposing the third surface 103 of the body 100.

Referring to FIGS. 1 to 4, the coil portion 310 may be disposed on the upper surface of the support member 200 to form a plurality of turns around the core 110, and an outermost turn may extend to be contact-connected to the second lead-out portion 332. The coil portion 310 may have a planar spiral shape, but the present disclosure is not limited thereto, and may also have an angled shape.

Referring to FIG. 5, an aspect ratio of the coil portion 310 may be greater than 0.04 and less than or equal to 15. Specifically, on a cross-section perpendicular to the first direction L, a ratio Tc1/LW1 of a thickness Tc1 of the coil portion 310 in the second direction T to a line width LW1 of the coil portion 310 may be greater than 0.04 and less than or equal to 15.

The coil 300 according to the present example embodiment may have a single-layer coil structure, such that the number of turns may be reduced to ½, as compared to the same-sized coil portions having a two-layer coil structure. In this case, the aspect ratio of the coil portion 310 may be increased, thereby securing the number of turns.

However, when a line width of the coil portion 310 is narrowed below a predetermined level, a sufficient plating thickness may not be implemented in a plating process. Table 1 below shows experimental data on whether the plating thickness and the number of coil turns are implemented according to a change in the aspect ratio of the coil portion 310. A sample used in an experiment may be a coil portion having a length of 1.0 mm, a width of 0.7 mm, and a thickness of 0.65 mm. It may be confirmed whether a desired plating thickness and the desired number of coil turns is implemented while changing the aspect ratio by controlling the line width and thickness to maintain a cross-sectional area of the coil portion 310. When the desired plating thickness or the desired number of coil turns is implemented, “OK” may be indicated. When a defect occurs in which the desired plating thickness or number of coil turns is not implemented, “NG” may be indicated.

TABLE 1

| | | | | | Whether | Whether the |
|---|---|---|---|---|---|---|
| | Coil dimension (μm) | | | Aspect | the plating | number of |
| Experimental | Pattern | Line | | ratio | thickness is | coil turns is |
| Example | distance | width | Thickness | (AR) | implemented | implemented |
| #1 | 8 | 5 | 300 | 60.000 | NG | OK |
| #2 | 8 | 6 | 250 | 41.667 | NG | OK |
| #3 | 8 | 7 | 214 | 30.571 | NG | OK |
| #4 | 8 | 8 | 188 | 23.500 | NG | OK |
| #5 | 8 | 9 | 167 | 18.556 | NG | OK |
| #6 | 8 | 10 | 150 | 15.000 | OK | OK |
| #7 | 8 | 15 | 100 | 6.667 | OK | OK |
| #8 | 8 | 20 | 75 | 3.750 | OK | OK |
| #9 | 8 | 25 | 60 | 2.400 | OK | OK |
| #10 | 8 | 30 | 50 | 1.667 | OK | OK |
| #11 | 8 | 35 | 43 | 1.229 | OK | OK |
| #12 | 8 | 40 | 38 | 0.950 | OK | OK |
| #13 | 8 | 45 | 33 | 0.733 | OK | OK |
| #14 | 8 | 50 | 30 | 0.600 | OK | OK |
| #15 | 8 | 60 | 25 | 0.417 | OK | OK |
| #16 | 8 | 70 | 21 | 0.300 | OK | OK |
| #17 | 8 | 80 | 19 | 0.238 | OK | OK |
| #18 | 8 | 90 | 17 | 0.189 | OK | OK |
| #19 | 8 | 100 | 15 | 0.150 | OK | OK |
| #20 | 8 | 110 | 14 | 0.127 | OK | OK |
| #21 | 8 | 120 | 13 | 0.108 | OK | OK |
| #22 | 8 | 130 | 12 | 0.092 | OK | OK |
| #23 | 8 | 140 | 11 | 0.079 | OK | OK |
| #24 | 8 | 150 | 10 | 0.067 | OK | OK |
| #25 | 8 | 160 | 9 | 0.056 | OK | OK |
| #26 | 8 | 170 | 9 | 0.053 | OK | OK |
| #27 | 8 | 180 | 8 | 0.044 | OK | OK |
| #28 | 8 | 190 | 8 | 0.042 | OK | OK |
| #29 | 8 | 200 | 8 | 0.040 | OK | NG |
| #30 | 8 | 210 | 7 | 0.033 | OK | NG |
| #31 | 8 | 220 | 7 | 0.032 | OK | NG |
| #32 | 8 | 230 | 7 | 0.030 | OK | NG |
| #33 | 8 | 240 | 6 | 0.025 | OK | NG |
| #34 | 8 | 250 | 6 | 0.024 | OK | NG |

Referring to Table 1 above, it may be confirmed that a defect occurs in which the desired plating thickness is not implemented when the aspect ratio of the coil portion 310 having a pattern forming a plurality of turns in the coil 300, that is, the ratio of the thickness to the line width, is greater than 15. In addition, it may be confirmed that a defect occurs in which the desired number of coil turns is not implemented when the aspect ratio of the coil portion 310 is 0.040 or less.

Accordingly, in the single-layer coil structure as in the present example embodiment, the aspect ratio of the coil portion 310 may be preferably formed to be greater than 0.04 and less than or equal to 15.

With respect to the above-described aspect ratio, a method of measuring the line width LW1 and thickness Tc1 of the coil portion 310 will be described with reference to FIG. 5.

With respect to an optical microscope or SEM image of a W-T cross-section of a central portion of the coil component 1000 in the first direction L, the line width LW1 of the coil portion 310 may refer to an arithmetic mean value of at least three dimensions among dimensions of a plurality of line segments connecting, to each other, two outermost boundary lines opposing each other in the third direction W of each turn of the coil portion 310 illustrated in the image, to be parallel to the third direction W, the plurality of line segments spaced apart from each other in the second direction T. Here, the plurality of line segments, parallel to the third direction W, may be equally spaced apart from each other in the second direction T, but the present disclosure is not limited thereto. Other methods and/or tools appreciated by one of ordinary skill in the art, even if not described in the present disclosure, may also be used.

The thickness Tc1 of the coil portion 310 may refer to an arithmetic mean value of at least three dimensions among dimensions of a plurality of line segments connecting, to each other, two outermost boundary lines opposing each other in the second direction T of each turn of the coil portion 310 illustrated in the image, to be parallel to the second direction T, the plurality of line segments spaced apart from each other in the third direction W. Here, the plurality of line segments, parallel to the second direction T, may be equally spaced apart from each other in the third direction W, but the present disclosure is not limited thereto.

Referring to FIG. 5, the coil portion 310 may have an upper surface opposing the fourth surface 104 of the body 100 and a lower surface opposing the third surface 103 of the body 100, and a surface roughness RL of a region of the lower surface of the coil portion 310, spaced apart from the support member 200, may be greater than a surface roughness Ru of the upper surface of the coil portion 310.

The above-described characteristic may occur in the process of removing the support member 200 except for a portion thereof corresponding to the first lead-out portion 331 after the coil 300 is plated on the support member 200, but the present disclosure is not limited thereto.

A region of the lower surface of the coil portion 310 spaced apart from the support member 200 may be formed to have a large surface roughness RL, such that bonding strength with the insulating film IF to be described below may be stronger.

As used herein, surface roughness may refer to central line average roughness Ra, and may be a value obtained by measuring using an optical surface profiler such as the 7300 Optical Surface Profiler manufactured by the Zygo Corporation, or using the surface roughness measuring instrument SV-3200 manufactured by the Mitutoyo Corporation. The surface roughness described above may be an arithmetic average of values measured in a T-axis direction with respect to a W-T cross-section, passing through a central portion of the upper or lower surface of the coil portion 310.

The first lead-out portion 331 may be disposed on the other surface of the support member 200, and may extend to the first recess R1 to be connected to the first external electrode 400. That is, at least a portion of the first lead-out portion 331 may be exposed to an external surface of the first recess R1 to be in contact with the first external electrode 400.

In particular, only the first lead-out portion 331 may be disposed on the other surface of the support member 200 of the coil component 1000 according to the present example embodiment without the coil portion 310 forming a turn.

Referring to FIG. 4, at least a portion of the first lead-out portion 331 may be coplanar with the first recess R1. Such a structure may be implemented by removing a portion of the first lead-out portion 331 when the first recess R1 is formed in the body 100 via pre-dicing.

Referring to FIGS. 1 and 4, a thickness of the first lead-out portion 331 in the second direction T may be less than a thickness of the coil portion 310 in the second direction T. The thicknesses may be measured by an optical microscope or SEM. Other methods and/or tools appreciated by one of ordinary skill in the art, even if not described in the present disclosure, may also be used.

In addition, the first lead-out portion 331 may have an upper surface in contact with the other surface of the support member 200, a lower surface opposing the upper surface, and a plurality of side surfaces connecting the upper surface and the lower surface to each other, and at least one of the plurality of side surfaces may be disposed to be in contact with the first external electrode 400.

The second lead-out portion 332 may be disposed on one surface of the support member 200, and may extend from an outermost turn of the coil portion 310 to the second surface 102 of the body 100 and the second recess R2 to be connected to a second external electrode 500. That is, at least a portion of the second lead-out portion 332 may be exposed to an external surface of the second recess R2 to be in contact with the second external electrode 500.

Referring to FIG. 4, at least a portion of the second lead-out portion 332 may be coplanar with the second recess R2. Such a structure may be implemented by removing a portion of the second lead-out portion 332 when the second recess R2 is formed in the body 100 via pre-dicing.

The first and second lead-out portions 331 and 332 according to the present example embodiment may have different thicknesses and shapes. For example, the first lead-out portion 331 may have a shape of a rectangular plate having a thin thickness, and the second lead-out portion 332 may be formed to have a thickness Tc the same as that of the coil portion 310.

Referring to FIGS. 2 to 4, the via 320 may connect an innermost turn of the coil portion 310 and the first lead-out portion 331 to each other. An end of the innermost turn of the coil portion 310 on one surface of the support member 200 and the first lead-out portion 331 on the other surface of the support member 200 may be directly connected to each other via the via 320 passing through the support member 200.

Via the coil 300 including the above-described elements, a signal input to the first external electrode 400 may be output to the second external electrode 500 via the first lead-out portion 331, the via 320, the coil portion 310, and the second lead-out portion 332. Respective elements of the coil 300 may generally function as a single coil connected between the first and second external electrodes 400 and 500 via such a structure.

At least one of the coil portion 310, the via 320, and the first and second lead-out portions 331 and 332 may include one or more conductive layers. For example, when the coil portion 310, the via 320, and the second lead-out portion 332 are formed by plating on one surface of the support member 200, each of the coil portion 310, the via 320, and the second lead-out portion 332 may include a first conductive layer formed by electroless plating or the like, and a second conductive layer disposed on the first conductive layer.

The first conductive layer may be a seed layer for forming the second conductive layer on the support member 200 by plating, and the second conductive layer may be an electroplating layer. Here, the electroplating plating layer may have a monolayer structure or a multilayer structure. The electroplating layer having a multilayer structure may be formed to have a conformal film structure in which one electroplating layer is covered by another electroplating layer, and may be formed to have a shape in which the other electroplating layer is laminated on only one surface of the one electroplating layer. A seed layer of the coil portion 310 and a seed layer of the second lead-out portion 332 may be integrated with each other, such that no boundary may be formed therebetween, but the present disclosure is not limited thereto. An electroplating layer of the coil portion 310 and an electroplating layer of the second lead-out portion 332 may be integrated with each other, such that no boundary may be formed therebetween, but the present disclosure is not limited thereto.

Each of the coil portion 310, the via 320, and the first and second lead-out portions 331 and 332 may be formed of a conductive material such as copper (Cu), aluminum (Al), silver (Ag), tin (Sn), gold (Au), nickel (Ni), lead (Pb), titanium (Ti), or alloys thereof, but the present disclosure is not limited thereto.

Referring to FIGS. 4 and 5, the coil component 1000 according to the present example embodiment may further include an insulating film IF within the body 100.

In the present example embodiment, the insulating film IF may cover the coil 300 and may integrally cover the coil 300 and the support member 200. The insulating film IF may insulate the coil portion 310 and the first and second lead-out portions 331 and 332 from the body 100.

Referring to FIGS. 4 and 5, the support member 200 disposed on the lower surface of the coil portion 310 may be removed except for a portion thereof corresponding to the first lead-out portion 331, and then may be covered by the insulating film IF, such that at least a portion of the lower surface of the coil portion 310 may be disposed to be in contact with the insulating layer IF.

The insulating film IF may include, for example, parylene or polyimide, but the present disclosure is not limited thereto. The insulating film IF according to the present example embodiment may be formed after a portion of the support member 200 is removed according to a process sequence, such that the insulating film IF may be preferably formed by a method such as vapor deposition. However, the present disclosure is not limited thereto, and may be formed by laminating films or the like.

In addition, as a non-limitative example, in a coreless structure in which the support member 200 is entirely removed, the insulating film IF may also function to support the coil 300 instead of the support member 200.

The insulating film IF may have a structure in which a portion of a plating resist used to form the coil 300 by electroplating is included, but the present disclosure is not limited thereto.

Referring to FIGS. 1, 3, and 4, the first and second external electrodes 400 and 500 may be disposed on the third surface 103 of the body 100 to be spaced apart from each other, and the first and second external electrodes 400 and 500 may extend to the first and second recesses R1 and R2 to be connected to the first lead-out portion 331 and the second lead-out portion 332, respectively.

Each of the first and second external electrodes 400 and 500 may include a connection portion disposed on the recesses R1 and R2 to be connected to the first lead-out portion 331 or the second lead-out portion 332, and a pad portion extending from the connection portion to the third surface 103 of the body 100. The connection portion and the pad portion may be integrated with each other, but the present disclosure is not limited thereto.

The pad portions of the external electrodes 400 and 500 may be in contact with a connection member such as a solder when the coil component 1000 is mounted on a printed circuit board, and may be formed on the third surface 103 of the body 100 to protrude further than the insulating layer 600. In a case in which the pad portions of the external electrodes 400 and 500 are formed to protrude as in the present example embodiment, when the coil component 1000 is mounted, an area of contact with a connection member such as a solder may be widened to increase adhesive strength, and a distance from a printed circuit board may also be increased to reduce the risk of a short circuit.

Referring to FIGS. 1 and 4, the external electrodes 400 and 500 may be formed along external surfaces of the recesses R1 and R2 and the third surface 103 of the body 100, respectively. For example, the external electrodes 400 and 500 may be in the form of a film conformal to the internal surfaces of the recesses R1 and R2 and the third surface 103 of the body 100. In this case, the external electrodes 400 and 500 may be formed using a thin film process such as a sputtering process or a plating process.

Referring to FIG. 4, at least a portion of the first external electrode 400 may be disposed to be in contact with the other surface of the support member 200. The above-described structure may be implemented by disposing the first external electrode 400 after the first recess R1 is formed to have a height H1 equal to a height of the other surface of the support member 200 in a pre-dicing process.

The external electrodes 400 and 500 may be formed of a conductive material such as copper (Cu), aluminum (Al), silver (Ag), tin (Sn), gold (Au), nickel (Ni), lead (Pb), chromium (Cr), titanium (Ti), or alloys thereof, but the present disclosure is not limited thereto.

Referring to FIGS. 1 and 4, the external electrodes 400 and 500 may have a multilayer structure. For example, the first layers 410 and 510 to which the external electrodes 400 and 500 are connected to the coil 300 may be copper (Cu) plating layers, or conductive resin layers including at least one of copper (Cu) or silver (Ag). Here, when the first layers 410 and 510 of the external electrodes 400 and 500 are formed of conductive resin layers, the first layers 410 and 510 may include a resin and a metal dispersed in the resin. The resin may include epoxy as a thermosetting resin, and the metal may include at least one of silver (Ag) or copper (Cu). For example, the conductive resin layer may be an Ag-Epoxy layer or a Cu-Epoxy layer, and may be formed by applying and curing a conductive paste including at least one of silver (Ag) or copper (Cu), but the present example embodiment is not limited thereto.

The second layers 420 and 520 may have a double-layer structure including a nickel (Ni) plating layer and a tin (Sn) plating layer.

In the external electrodes 400 and 500 according to the present example embodiment, the first layers 410 and 510 may be disposed on the recesses R1 and R2 to extend to the third surface 103 of the body 100, and the second layers 420 and 520 may be additionally disposed to cover regions of the first layers 410 and 510, disposed on the third surface 103 of the body 100. That is, when the coil component 1000 is mounted on a PCB board, the second layers 420 and 520 may be included in a pad portion in direct contact with a solder.

The first layers 410 and 510 may be formed by electroplating, by vapor deposition such as sputtering, or by applying and curing a conductive paste including conductive powder such as copper (Cu) and/or silver (Ag), and the second layers 420 and 520 may be formed by electroplating.

The coil component 1000 according to the present example embodiment may further include an insulating layer 600 covering the body 100 and at least a portion of the first and second external electrodes 400 and 500 disposed on the recesses R1 and R2, the insulating layer 600 exposing a region of the first and second external electrodes 400 and 500 disposed on the third surface 103 of the body 100.

Referring to FIGS. 1, 4, and 5, the insulating layer 600 may cover the first to sixth surfaces 101, 102, 103, 104, 105, and 106 of the body 100, and may be disposed on the third surface 103 of the body 100 to expose the first and second external electrodes 400 and 500.

In addition, the insulating layer 600 may be disposed on the first and second surfaces 101 and 102 of the body 100 to cover at least a portion of the external electrodes 400 and 500 disposed on the recesses R1 and R2, or filling portions 610 and 620 to be described below.

The insulating layer 600 may be disposed to have a thickness less than that of each of the external electrodes 400 and 500. In this case, the external electrodes 400 and 500 may have a portion protruding to a mounting surface. That is, external surfaces of the second layers 420 and 520 may be disposed to protrude further than an external surface of the insulating layer 600.

Thus, in a case in which the external electrodes 400 and 500 are disposed to protrude further than the insulating layer 600, when the coil component 1000 is mounted, an area of contact with a connection member such as a solder may be widened to increase adhesive strength, and a distance from a printed circuit board may also be increased to reduce the risk of a short circuit.

The insulating layer 600 may be formed, for example, by applying and curing an insulating material including an insulating resin to a surface of the body 100. In this case, the insulating layer 600 may include at least one of a thermoplastic resin such as a polystyrene-based resin, a vinyl acetate-based resin, a polyester-based resin, a polyethylene-based resin, a polypropylene-based resin, a polyamide-based resin, a rubber-based resin, an acryl-based resin, or the like, a thermosetting resin such as a phenol-based resin, an epoxy-based resin, a urethane-based resin, a melamine-based resin, an alkyd-based resin, or the like, and a photosensitive insulating resin.

Referring to FIG. 4, the coil component 1000 according to the present example embodiment may further include filling portions 610 and 620 disposed between the recesses R1 and R2 and the insulating layer 600.

The filling portions 610 and 620 may improve the exterior of the coil component 1000 and improve the printing quality of the insulating layer 600 by filling edge regions being depressed due to the formation of the recesses R1 and R2.

In the present example embodiment, the first and second filling portions 610 and 620 may be disposed to cover the external electrodes 400 and 500 disposed on the recesses R1 and R2, respectively.

Side surfaces of the filling portions 610 and 620 may be substantially coplanar with the first surface 101, the second surface 102, the fifth surface 105, and the sixth surface 106 of the body 100. That is, the side surfaces of the first filling portion 610 may be disposed to be substantially coplanar with the first, fifth, and sixth surfaces 101, 105, and 106 of the body 100, and the side surfaces of the second filling portion 620 may be disposed to be substantially coplanar with the second, fifth, and sixth surfaces 102, 105, and 106 of the body 100. Here, being substantially coplanar refers to being able to share substantially the same plane including a process error.

The filling portions 610 and 620 may be formed on the external electrodes 400 and 500 disposed on the recesses R1 and R2 by a method such as a printing method, a vapor deposition method, a spray coating method, a film lamination method, and the like, but the present disclosure is not limited thereto. The filling portions 610 and 620 may be formed of a thermoplastic resin such as a polystyrene-based resin, a vinyl acetate-based resin, a polyester-based resin, a polyethylene-based resin, a polypropylene-based resin, a polyamide-based resin, a rubber-based resin, an acryl-based resin, or the like, a thermosetting resin such as a phenol-based resin, an epoxy-based resin, a urethane-based resin, a melamine-based resin, an alkyd-based resin, or the like, a photosensitive resin, parylene, SiOx or SiNx.

In the present example embodiment, the filling portions 610 and 620 may be omitted. In this case, the insulating layer 600 may be disposed to have a greater thickness in a region in which the filling portions 610 and 620 are to be disposed, but the present disclosure is not limited thereto.

### Second Example Embodiment

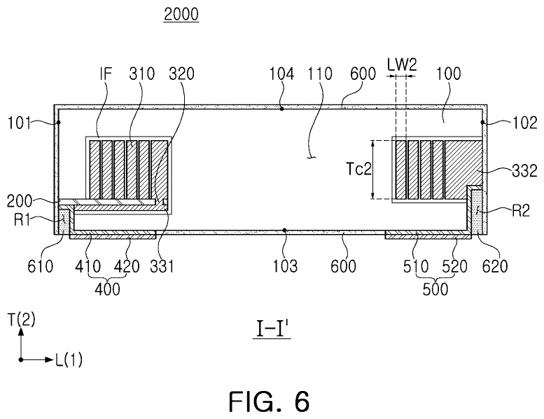

FIG. 6 illustrates a coil component 2000 according to a second example embodiment of the present disclosure, and is a view corresponding to FIG. 4.

Referring to FIG. 6, the present example embodiment may be different from the first example embodiment in terms of an aspect ratio of a coil 300. That is, a coil portion 310 and a second lead-out portion 332 according to the present example embodiment may have a higher aspect ratio due to a narrower line width LW2 and a greater thickness Tc2 than those in the first example embodiment. Accordingly, the coil portion 310 may have more turns.

Accordingly, in describing the present example embodiment, only the aspect ratio of the coil 300 and the number of turns of the coil portion 310, different from those of the first example embodiment of the present disclosure, will be described. The description of the first example embodiment of the present disclosure may be applied to remaining elements of the present example embodiment in the same manner.

Referring to FIG. 6, in the coil component 2000 according to the present example embodiment, a line width LW2 of the coil portion 310 may be formed to be narrower than the line width LW1 of the coil portion 310 according to the first example embodiment. In addition, a thickness Tc2 of the coil portion 310 in a second direction T may be formed to be greater than the thickness Tc1 of the coil portion 310 according to the first example embodiment.

As a result, the coil portion 310 according to the present example embodiment may have a high aspect ratio, and the number of turns may be increased within the body 100 having the same size, thereby improving inductance characteristics.

For example, referring to FIGS. 2 and 4, the coil portion 310 according to the first example embodiment may form 2.5 turns. As compared to the above-described case, referring to FIG. 6, the coil portion 310 according to the second example embodiment may form 5 turns, thereby implementing the coil component 2000 having a large number of turns within the same size.

However, even in the present example embodiment, the coil portion 310 may be preferably formed to have an aspect ratio of 15 or less in view of the experimental results of Table 1 described above.

### Third Example Embodiment

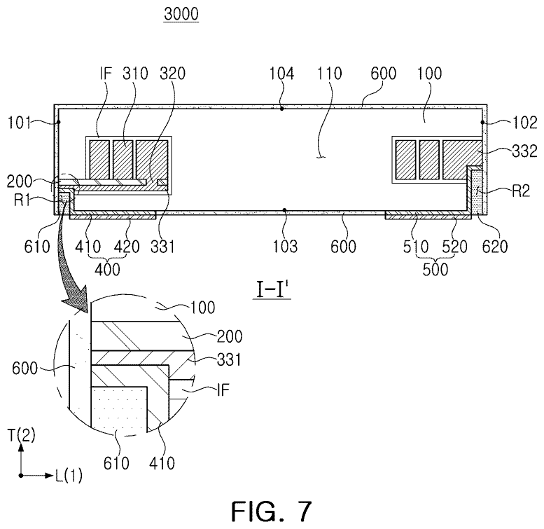

FIG. 7 illustrates a coil component 3000 according to a third example embodiment of the present disclosure, and is a view corresponding to FIG. 4.

Referring to FIG. 7, the present example embodiment may be different from the first example embodiment in that a portion of a first lead-out portion 331 is disposed between a first recess R1 and a support member 200.

Accordingly, in describing the present example embodiment, the support member 200, the first lead-out portion 331, the first recess R1, and a first external electrode 400 disposed therein, different from those in the first example embodiment, will be described. The description of the first example embodiment of the present disclosure may be applied to remaining elements of the present example embodiment in the same manner.

Referring to FIG. 7, at least a portion of the first lead-out portion 331 may be disposed between the other surface of the support member 200 and the first recess R1. That is, during a pre-dicing process for forming the first recess R1, unlike the first example embodiment, the first recess R1 may be formed to have a margin having a predetermined distance from the other surface of the support member 200.

As a result, referring to the enlarged view of FIG. 7, an area of contact between a first layer 410 disposed on the first recess R1 of the first external electrode 400 and the first lead-out portion 331 may be widened, thereby improving connection reliability between the coil 300 and the first external electrode 400.

### Fourth Example Embodiment

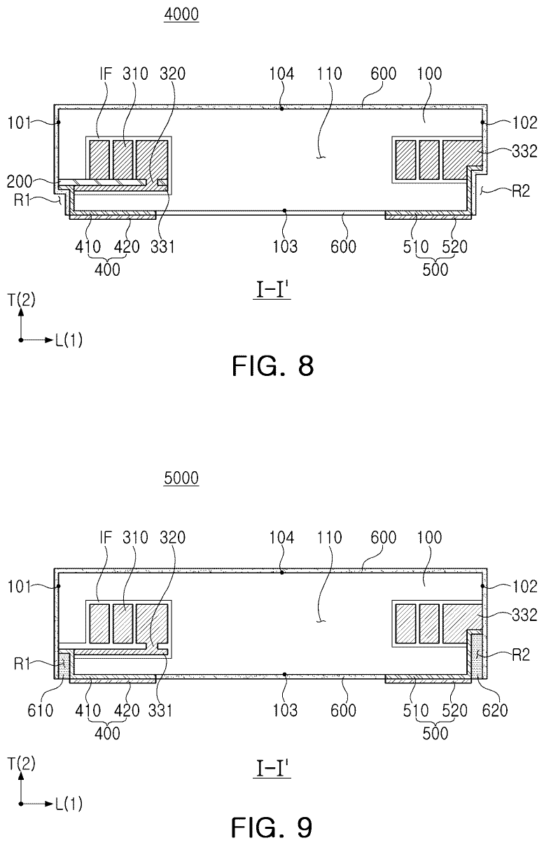

FIG. 8 illustrates a coil component according to a fourth example embodiment of the present disclosure, and is a view corresponding to FIG. 4.

Referring to FIG. 8, the present example embodiment may be different from the first example embodiment in that filling portions 610 and 620 are omitted, and external electrodes 400 and 500 on recesses R1 and R2 are directly formed by an insulating layer 600.

Accordingly, in describing the present example embodiment, only the arrangement of external electrodes 400 and 500 and an insulating layer 600 on recesses R1 and R2, and an overall shape of the coil component 4000, different from those in the first example embodiment of the present disclosure, will be described. The description of the first example embodiment of the present disclosure may be applied to remaining elements of the present example embodiment in the same manner.

Referring to FIG. 8, in the coil component 4000 according to the present example embodiment, the insulating layer 600, covering a first surface 101 and a second surface 102 of a body 100, may be conformally disposed along an external surface shape of each of the external electrodes 400 and 500 disposed on the recesses R1 and R2.

That is, the filling portions 610 and 620 may be filled or the insulating layer 600 may be disposed so as not to have a greater thickness in regions being concave due to the recesses R1 and R2, such that the exterior of the coil component 4000 may have shapes of the recesses R1 and R2.

In the present example embodiment, a process of disposing the filling portions 610 and 620 on the external electrodes 400 and 500 on the recesses R1 and R2 or an additional insulation printing process may be omitted to reduce lead time, thereby increasing process efficiency.

In addition, a total area of a mounting surface of the coil component 4000 may be reduced, such that the risk of short circuit with adjacent components occurring when the coil component 4000 is mounted on a PCB board may be reduced, and a space of an outer end region of each of the external electrodes 400 and 500 in which a solder is to be disposed during mounting may also be secured, thereby preventing rotation or movement of the coil component 4000.

In addition, a surface of the body 100 or a direction of arrangement of the coil 300 may be externally verified due to an asymmetrical shape of the coil component 4000, thereby omitting marking for specifying a magnetic flux direction.

### Fifth Example Embodiment

FIG. 9 illustrates a coil component 5000 according to a fifth example embodiment of the present disclosure, and is a view corresponding to FIG. 4.

Referring to FIG. 9, the present example embodiment may be different from the first example embodiment in that a support member 200 is omitted and an insulating film IF is additionally disposed in a space in which the support member 200 is omitted.

Accordingly, in describing the present example embodiment, only the support member 200 and the insulating film IF, different from those of the first example embodiment of the present disclosure, will be described. The description of the first example embodiment of the present disclosure may be applied to remaining elements of the present example embodiment in the same manner.

Referring to FIG. 9, a coil 300 may be integrally covered and simultaneously supported by the insulating film IF. The present example embodiment may have a coreless structure in which the support member 200 is omitted. After the coil 300 is disposed on the support member 200, the support member 200 may be entirely removed, and then the insulating film IF may be formed, thereby implementing the present example embodiment.

Alternatively, after a coil portion 310 and a second lead-out portion 332 is disposed on the support member 200, the support member 200 may be entirely removed. Subsequently, the coil portion 310 and the second lead-out portion 332 may be integrally covered by the insulating film IF, the insulating film IF may be partially removed such that an innermost turn of the coil portion 310 is partially exposed, a via 320 and a first lead-out portion 331 may be disposed in the removed space, and the insulating film IF may be additionally formed, thereby implementing the present example embodiment. In this case, an interface may be formed within the insulating film IF, but the present disclosure is not limited thereto.

In both cases described above, the via 320 may be disposed to pass through the insulating layer IF.

In the present example embodiment, the insulating film IF may include parylene or polyimide, and may be formed by a method such as vapor deposition or film lamination, but the present disclosure is not limited thereto.

While example embodiments have been illustrated and described above, it will be apparent to those skilled in the art that modifications and variations could be made without departing from the scope of the present disclosure as defined by the appended claims.

What is claimed is:

1. A coil component comprising:
a body having:
a first surface and a second surface opposing each other in a first direction, the first surface and the second surface respectively having a recess, and
a third surface and a fourth surface connecting the first surface and the second surface to each other, the third surface and the fourth surface opposing each other in a second direction;
a coil including:
a coil portion disposed within the body, the coil portion having a plurality of turns,
a first lead-out portion disposed within the body, the first lead-out portion extending to the recess of the first surface of the body, and
a second lead-out portion having at least a portion extending from an outermost turn of the coil portion to the recess of the second surface of the body; and
first and second external electrodes disposed on the third surface of the body, the first and second external electrodes extending to the recess to be connected to the first and second lead-out portions, respectively.

2. The coil component of claim 1, further comprising:
a support member disposed within the body, the support member having one surface and the other surface opposing each other,
wherein at least a portion of the coil portion is disposed on the one surface of the support member, and at least a portion of the first lead-out portion is disposed on the other surface of the support member.

3. The coil component of claim 1, wherein the coil further includes a via connecting an innermost turn of the coil portion and the first lead-out portion to each other.

4. The coil component of claim 2, wherein the support member is in contact with the first surface of the body, and is spaced apart from the second surface of the body.

5. The coil component of claim 4, wherein the support member is disposed in a region adjacent to the first surface of the body with respect to a central portion of the body in the first direction.

6. The coil component of claim 1, wherein
the recess includes a first recess between the first surface and the third surface of the body, and a second recess between the second surface and the third surface of the body, and
a maximum length of the first recess in the first direction is shorter than a minimum length between the outermost turn of the coil portion and the first surface of the body in the first direction.

7. The coil component of claim 1, wherein an aspect ratio of the coil portion is greater than 0.04 and less than or equal to 15.

8. The coil component of claim 7, wherein, on a cross-section perpendicular to the first direction, a ratio (Tc/LW) of a thickness (Tc) of the coil portion in the second direction to a line width (LW) of the coil portion is greater than 0.04 and less than or equal to 15.

9. The coil component of claim 2, wherein
the coil portion has an upper surface opposing the fourth surface of the body and a lower surface opposing the third surface of the body, and
a surface roughness of a region of the lower surface of the coil portion spaced apart from the support member is greater than a surface roughness of the upper surface of the coil portion.

10. The coil component of claim 1, further comprising:
an insulating film covering the coil,
wherein at least a portion of a lower surface of the coil portion is in contact with the insulating film.

11. The coil component of claim 1, wherein
the recess includes a first recess between the first surface and the third surface of the body, and a second recess between the second surface and the third surface of the body, and
a height of the first recess in the second direction is lower than a height of the second recess in the second direction.

12. The coil component of claim 11, wherein
at least a portion of the first lead-out portion is coplanar with the first recess, and
at least a portion of the second lead-out portion is coplanar with the second recess.

13. The coil component of claim 1, wherein a thickness of the first lead-out portion in the second direction is less than a thickness of the coil portion in the second direction.

14. The coil component of claim 2, wherein at least a portion of the first external electrode is in contact with the other surface of the support member.

15. The coil component of claim 2, wherein at least a portion of the first lead-out portion is disposed between the other surface of the support member and the recess.

16. The coil component of claim 2, wherein, when projected in the second direction, outermost boundaries of the support member and the first lead-out portion have shapes corresponding to each other.

17. The coil component of claim 1, wherein
the body has a fifth surface and a sixth surface opposing each other in a third direction, perpendicular to the first and second directions, and
the recess extends up to the fifth surface and the sixth surface of the body in the third direction.

18. The coil component of claim 1, further comprising:
an insulating layer covering the body and at least a portion of the first and second external electrodes disposed on the recess, the insulating layer exposing regions of the first and second external electrodes disposed on the third surface of the body.

19. The coil component of claim 18, further comprising:
first and second filling portions respectively disposed between the insulating layer and regions of the first and second external electrodes disposed on the recess.

20. The coil component of claim 1, wherein regions of the first and second external electrodes, disposed on the third surface of the body, include a plurality of layers, respectively.

21. The coil component of claim 20, wherein the plurality of layers include a first layer disposed on the third surface of the body, and a second layer disposed on the first layer.

22. The coil component of claim 1, wherein the coil has a single-layer coil structure.

23. The coil component of claim 1, wherein the recess in the second surface of the body is in contact with the second lead-out portion.

24. A coil component comprising:
a body having a first surface and a second surface respectively having a recess, the first surface and the second surface opposing each other;
a support member disposed within the body, the support member having one surface and the other surface opposing each other;
a coil including:
a coil portion in contact with the one surface of the support member but not the other surface of the support member, the coil portion having a plurality of turns, wherein an aspect ratio of each of the plurality of turns is greater than 0.04 and less than or equal to 15,
a first lead-out portion disposed on the other surface of the support member, the first lead-out portion extending to the first surface of the body,
a via passing through the support member to connect an innermost turn of the coil portion and the first lead-out portion to each other, and
a second lead-out portion extending from an outermost turn of the coil portion to the second surface of the body; and
first and second external electrodes disposed along an external surface of the recess, the first and second external electrodes respectively connected to the first and second lead-out portions.

25. The coil component of claim 24, wherein the recess in the first surface of the body and the recess in the second surface of the body have different cross-sectional areas.

26. The coil component of claim 24, wherein
the first lead-out portion has:
an upper surface in contact with the other surface of the support member,
a lower surface opposing the upper surface, and
a plurality of side surfaces connecting the upper surface and the lower surface to each other, and
the first external electrode is in contact with at least one of the plurality of side surfaces of the first lead-out portion.

27. The coil component of claim 24, wherein the coil has a single-layer coil structure.

28. The coil component of claim 24, wherein the recess in the second surface of the body is in contact with the second lead-out portion.
